(19) United States
(12) Patent Application Publication
(10) Pub. No.: US 2015/0145623 A1
(43) Pub. Date: May 28, 2015

(54) EXTENDED-WIDTH FLEXIBLE MAGNETIC SHEET

(71) Applicant: Arnold Magnetic Technologies, Rochester, NY (US)

(72) Inventors: James P. McNerney, Marietta, OH (US); Ferris J. Arnold, Marietta, OH (US); Bernard W. Hendershot, Marietta, OH (US)

(73) Assignee: Arnold Magnetic Technologies, Rochester, NY (US)

(21) Appl. No.: 14/088,419

(22) Filed: Nov. 24, 2013

(51) Int. Cl. H01F 7/02; B32B 37/18

(52) U.S. Cl. CPC H01F 7/02; B32B 37/18; B32B 2307/208
USPC 335/296; 156/60

(57) ABSTRACT

Apparatus and methods for an extended-width flexible magnetic sheet (“EWFMS”) are provided. The EWFMS may include a first layer. The first layer may include a first sheet of magnetic material, a second sheet of magnetic material and a joint between the first sheet and the second sheet. The EWFMS may include a second layer. The second layer may include a third sheet of magnetic material, a fourth sheet of magnetic material and a joint between the third sheet and the fourth sheet. The EWFMS may include a first vinyl layer. The first vinyl layer may join the first sheet to the second sheet. The first vinyl layer may cover the joint along a length of the EWFMS. The EWFMS may include a second vinyl layer affixed to the first vinyl layer. The EWFMS may include a polymer layer affixed to an underside of the EWFMS.

### FIELD OF TECHNOLOGY

Aspects of the present disclosure relate to joining two or more flexible magnetic sheets to form an extended-width flexible-magnetic sheet.

### BACKGROUND

The flexible magnet industry produces magnetic sheets having a width and a length. The magnetic sheet may be flexible and rolled along the length of the sheet. A flexible magnetic sheet may be used to manufacture a flexible magnetic sign. A flexible magnetic sign may be easily mounted on metallic surfaces. Flexible magnetic signs may be easily removed from metallic surfaces. Typically, a flexible magnetic sign may be limited in size by the width and length of the flexible magnetic sheet. However, a business may desire a sign that is larger than a single magnetic sheet.

Therefore it would be desirable to provide apparatus and methods for producing an extended-width flexible magnetic sheet that is suitable for printing signage.

### BRIEF DESCRIPTION OF THE DRAWINGS

FIG. 1 shows a perspective view of an illustrative apparatus in accordance with principles of the invention;

FIG. 2 shows a cross-section of an illustrative apparatus in accordance with principles of the invention;

FIG. 3 shows a cross-section of an illustrative apparatus in accordance with principles of the invention;

FIG. 4 shows a cross-section of an illustrative apparatus in accordance with principles of the invention;

FIG. 5 shows a cross-section of an illustrative apparatus in accordance with principles of the invention;

FIG. 6 shows a cross-section of an illustrative apparatus in accordance with principles of the invention;

FIG. 7 shows a top-down view of an illustrative apparatus in accordance with principles of the invention; and

FIG. 8 shows a top-down view of an illustrative apparatus in accordance with principles of the invention;

FIG. 9 shows a perspective view of an illustrative apparatus in accordance with principles of the invention; and

FIG. 10 shows a cross-section of an illustrative apparatus in accordance with principles of the invention.

### DETAILED DESCRIPTION

Apparatus and methods for constructing an extended-width flexible magnetic sheet (“EWFMS”) are provided.

Methods may include aligning a first flexible magnetic sheet with a second flexible magnetic sheet. Methods may include joining a first flexible magnetic sheet to a second flexible magnetic sheet. The first and/or second magnetic sheet may be magnetized before the joining. The first and/or second magnetic sheet may be magnetized after the joining.

The aligning may include joining the first flexible magnetic sheet to the second flexible magnetic sheet. Aligning and/or joining of the first flexible magnetic sheet and the second flexible magnetic sheet may form a joint. The joint may extend along a length of the EWFMS. The length of the joint may correspond to a length of the EWFMS. Aligning and/or joining of the first flexible magnetic sheet and the second flexible magnetic sheet may form a layer of the EWFMS.

Aligning and/or joining of the first flexible magnetic sheet and the second flexible magnetic sheet may form a surface area of the EWFMS. The surface area may be a top surface of the EWFMS. The surface area may be a bottom surface of the EWFMS. The surface area may have a length corresponding to a length of the first magnetic sheet. The surface area may have a length corresponding to a length of the second magnetic sheet. The joint may run along the length of the surface area. The surface area may have a width. The width may be greater than a width of the first magnetic sheet. The width may be greater than a width of the second magnetic sheet. The width of the surface area of the EWFMS may be between 30-90 inches.

The surface area may have a width substantially corresponding to a sum of a width of the first flexible magnetic sheet and a width of the second flexible magnetic sheet. The surface area of the EWFMS may be substantially double the size of a surface area of the second flexible magnetic sheet. The surface area may have width equal to a sum of a width of the first flexible magnetic sheet and a width of the second flexible magnetic sheet, less a width of the joint. The surface area of the EWFMS may be substantially double the size of a surface area of the first flexible sheet.

Methods may include covering at least a portion of the surface area of the EWFMS with a vinyl layer. The vinyl layer may include a pressure sensitive adhesive. Methods may include spraying the vinyl layer onto the surface area of the EWFMS. Any suitable method of applying the vinyl layer may be utilized. For example, an adhesive may be applied to the surface area of the EWFMS. The vinyl layer may be applied above the adhesive. The vinyl layer may be coated with an adhesive. The vinyl layer may include an adhesive layer.

The vinyl layer may have a thickness between 1/1000 of an inch and 10/1000 of an inch. The vinyl layer may cover substantially all of the surface area of the EWFMS. The vinyl layer may cover the joint between the first magnetic sheet and the second magnetic sheet. The vinyl layer may cover, along a length of the EWFMS, the joint and the surface area of the EWFMS.

The aligning may include forming the joint by positioning a portion of the first flexible magnetic sheet underneath a portion of the second flexible magnetic sheet. The portion of the first flexible magnetic sheet may be shaped such that the portion of the first flexible magnetic sheet is complementary to the portion of the second flexible magnetic sheet. A thickness of the EWFMS may be substantially one value at any point on the surface area of the EWFMS. The surface area may include the joint. The EWFMS may have a uniform thickness throughout the surface area of the EWFMS.

The aligning and/or joining may include applying an adhesive to the first flexible magnetic sheet. The adhesive may have a thickness between 0.5/1000 of an inch and 2/1000 of an inch. The adhesive may be applied to an edge of the first flexible magnetic sheet. The adhesive may be applied to the edge along a length of the first flexible magnetic sheet.

The adhesive may join the edge of the first flexible magnetic sheet to an edge of the second flexible magnetic sheet. The adhesive may be applied to the second flexible magnetic sheet. The adhesive may maintain an alignment of the first with respect to the second magnetic sheet. The adhesive may reduce a buckling of the vinyl layer when the EWFMS is flexed.

In some embodiments, methods may include applying an adhesive along a length of the joint. The adhesive may be applied after the aligning and/or joining of the first and second magnetic sheets. The adhesive may be applied before aligning and/or joining the first magnetic sheet to the second magnetic sheet. The adhesive may be applied to a mating surface of the joint.

The aligning and/or joining may include welding the first magnetic sheet to the second magnetic sheet along a length of the joint. The welding may fix a position of the first magnetic sheet with respect to the second magnetic sheet.

The methods may include positioning a strip of flexible magnetic material along a length of the joint. The joint may include the flexible magnetic strip. The flexible magnetic strip may be positioned along a center of the joint. The positioning of the flexible magnetic strip may fill a gap between the first flexible magnetic sheet and the second flexible magnetic sheet. Inserting the flexible magnetic strip into the joint may reduce a buckling of the vinyl layer when the EWFMS is flexed.

The aligning may include forming the joint by interlocking the first flexible magnetic sheet with the second flexible magnetic sheet. For example, the first flexible magnetic sheet may include protrusions that interlock with grooves in the second flexible magnetic sheet and vice versa. Forming the joint by interlocking may reduce a buckling of the vinyl layer when the EWFMS is flexed. Forming the joint by interlocking may reduce a buckling of the vinyl layer when the EWFMS is flexed without applying an adhesive to either the first or second flexible magnetic sheet.

Methods may include aligning a third flexible magnetic sheet with a fourth flexible magnetic sheet. Aligning and/or joining of the third flexible magnetic sheet and the fourth flexible magnetic sheet may form a layer of the EWFMS.

The aligning may include joining the third flexible magnetic sheet to the fourth flexible magnetic sheet. Aligning and/or joining of the third flexible magnetic sheet and the fourth flexible magnetic sheet may form a joint. The joint may extend along a length of the EWFMS. The length of the joint may correspond to a length of the EWFMS.

Aligning and/or joining of the third flexible magnetic sheet and the fourth flexible magnetic sheet may form a surface area of the EWFMS. The first and second flexible magnetic sheets may be aligned to form a first surface area. The third and fourth flexible magnetic sheets may be aligned to form a second surface area.

The second surface area may be a top surface of the EWFMS. The second surface area may be a bottom surface of the EWFMS. The second surface area may have a length corresponding to a length of the third magnetic sheet. The second surface area may have a length corresponding to a length of the fourth magnetic sheet. A joint may run along the length of the second surface area. The second surface area may have a width. The width may be greater than a width of the third magnetic sheet. The width may be greater than a width of the fourth magnetic sheet. The width of the second surface area of the EWFMS may be between 30-90 inches. The width of the second surface areas may be identical to the width of the first surface area.

The first and second flexible magnetic sheets may each have a thickness of between 5/1000 and 30/1000 of an inch. The third and fourth flexible magnetic sheets may each have a thickness of between 5/1000 and 30/1000 of an inch. In a preferred embodiment, a total thickness of a flexible magnetic portion of the EWFMS may be 30/1000 of an inch.

The methods may include affixing the first and second flexible magnetic sheets to the third and fourth flexible magnetic sheets. The first and second flexible magnetic sheets may be affixed to the third and fourth flexible magnetic sheets after aligning the first and second flexible magnetic sheets. The first and second flexible magnetic sheets may be affixed to the third and fourth flexible magnetic sheets after aligning the third and fourth flexible magnetic sheets. Flexible magnetic sheets may be affixed to each other using a pressure sensitive adhesive.

The methods may include rolling the EWFMS along a length of the joint. The rolling may reduce a footprint of the EWFMS. The EWFMS may be easily transported after being rolled. A rolled EWFMS may have a length corresponding to a width of the surface area of the EWFMS. The rolled EWFMS may have a diameter proportional to a length of the surface area of the EWFMS.

The methods may include feeding the EWFMS into a printer. The printer may be capable of printing on sheets having a width of 30-90 inches or more. The EWFMS may utilize 30 inches, 90 inches or more of the printing capability of the printer. The methods may include printing on the vinyl layer of the EWFMS.

Covering the surface area of the EWFMS with the vinyl layer may substantially fix an alignment and/or attachment of the first flexible magnetic sheet with respect to the second flexible magnetic sheet. The vinyl layer may fix a position of the first flexible magnetic sheet with respect to the second flexible magnetic sheet. The joint may include a portion of the vinyl layer.

Apparatus for an extended-width flexible magnetic sheet (“EWFMS”) are provided.

The EWFMS may have a length. The EWFMS may include a first sheet of magnetic material. The first sheet may have a first width W₁. The EWFMS may include a second sheet of magnetic material. The second sheet may have a second width W₂. The first width W₁ may equal the second width W₂. For example, the W₁ and W₂ may each be 24 inches. The first width W₁ may be greater than the second width W₂. For example, W₁ may be 30 inches and W₂ may be 18 inches.

The first sheet may be aligned with a second sheet. Aligning the first sheet with the second sheet may form a first magnetic sheet layer of the EWFMS. The first magnetic sheet layer may have a thickness between 5/1000 and 30/1000 of an inch.

The first magnetic sheet layer may have a width Wₛ₁. Width Wₛ₁ may be greater than W₁. Width Wₛ₁ may be greater than W₂. For example, W₁ and W₂ may each be 24 inches and Wₛ₁ may be 48 inches. As a further example, W₁ and W₂ may each be 24 inches. The first magnetic sheet may overlap the second magnetic sheet and Wₛ₁ may be 47 inches.

The EWFMS may include a first joint between the first sheet and the second sheet. The first joint may run along at least a portion of the length. The first joint may include an edge of the first magnetic sheet. The first joint may include an edge of the second magnetic sheet. The first magnetic sheet may be joined to the second magnetic sheet by gluing the edge of the first magnetic sheet to the edge of the second magnetic sheet.

The EWFMS may include a third sheet of magnetic material. The third sheet may have a third width W₃. The EWFMS may include a fourth sheet of magnetic material. The fourth sheet may have a fourth width W₄. The third width W₃ may equal the fourth width W₄. For example, W₃ and W₄ may each be 24 inches. W₃ may be greater than W₄. For example, W₃ may be 25 inches and W₄ may be 23 inches.

In some embodiments, W₁ may equal W₃. In some embodiments, W₂ may equal W₄. In a preferred embodiment, W₁+W₂=W₃+W₄.

The third magnetic sheet may be aligned with the fourth magnetic sheet. Aligning the third magnetic sheet with the fourth magnetic sheet may form a second magnetic sheet layer of the EWFMS. The second magnetic sheet layer may have a thickness between 5/1000 and 30/1000 of an inch.

The second magnetic sheet layer may have a width Wₛ₂. Width Wₛ₂ may be greater than W₃. Width Wₛ₂ may be greater than W₄. For example, W₃ may be 18 inches and W₄ may be 30 inches and width Wₛ₂ may be 48 inches.

The first magnetic sheet layer may be superimposed on the second magnetic sheet layer. In one example, Wₛ₁ may equal Wₛ₂. A bottom of the first magnetic sheet layer may be positioned above a top of the second magnetic sheet layer. The EWFMS may include an adhesive between the first magnetic sheet layer and the second magnetic sheet layer. The adhesive may be an adhesive layer. The adhesive may join the first magnetic sheet layer to the second magnetic sheet layer. An EWFMS may include a magnetic sheet section of two or more magnetic sheet layers. A thickness of the magnetic sheet section of the EWFMS may be between 10/1000 and 60/1000 of an inch.

The adhesive may cover substantially an entire surface of the first magnetic sheet layer. The adhesive may cover substantially an entire surface of the second magnetic sheet layer. The adhesive may be a pressure sensitive adhesive. The adhesive may be applied to the top of the second magnetic sheet layer. The adhesive may be applied to the bottom of the first magnetic sheet layer.

The adhesive may maintain a position of the first magnetic sheet with respect to the second magnetic sheet. The adhesive may maintain a position of the third magnetic sheet with respect to the fourth magnetic sheet. The adhesive may maintain a position of the first magnetic sheet with respect to the third magnetic sheet. The adhesive may maintain a position of the second magnetic sheet with respect to the third magnetic sheet. The adhesive may maintain a position of one of the magnetic sheets with respect to the other three magnetic sheets.

The EWFMS may include a second joint between the third sheet and the fourth sheet. The second joint may run along at least a portion of the length. The second joint may include an edge of the third magnetic sheet. The second joint may include an edge of the fourth magnetic sheet. The third magnetic sheet may be joined to the fourth magnetic sheet by gluing the edge of the third magnetic sheet to the edge of the fourth magnetic sheet.

The second joint may be offset from the first joint by a distance. The distance may be any suitable distance. In a preferred embodiment, the distance may be greater than or equal to one inch. For example, W₁ and W₂ may each be 24 inches. W₃ may be 25 inches and W₄ may be 23 inches, offsetting the second joint from the first joint by one inch.

Offsetting the second joint from the first joint may increase a bending resistance of the EWFMS along the first joint. For example, a solid portion of a third sheet may be positioned directly below the first joint. A tendency of the EWFMS to flex about the first joint may be resisted by a thickness of the third magnetic sheet.

Offsetting the second joint from the first joint may increase a bending resistance of the EWFMS along the second joint. For example, a solid portion of a first sheet may be positioned directly above the second joint. A tendency of the EWFMS to flex about the second joint may be resisted by a thickness of the first magnetic sheet.

The EWFMS may include a printable layer. A printable layer, such as vinyl, may be applied to a top of the first magnetic sheet layer. Constructing the EWFMS from two layers of magnetic sheeting may reduce a tendency of the vinyl layer to buckle and/or crease when the EWFMS flexes about a joint in one of the layers.

For example, a magnetic sheet section of the EWFMS may have a thickness of 30/1000 of an inch. The thickness may include a thickness of a first magnetic sheet layer of 15/1000 of an inch. The first layer may include a first magnetic sheet joined to a second magnetic sheet. A first joint between the first and second magnetic sheets may have a maximum thickness of 15/1000 of an inch. The thickness may include a thickness of a second magnetic sheet layer of 15/1000 of an inch. The second layer may include a third magnetic sheet and a fourth magnetic sheet. A second joint between the third sheet and the fourth sheet may have a maximum thickness of 15/1000 of an inch.

Offsetting the second joint from the first joint may reduce a buckling of a vinyl layer when the EWFMS is flexed along an axis parallel to the length. The offset may position a thickness of a magnetic sheet below the joint. A thickness of a magnetic sheet positioned below the joint may reduce a tendency of the EWFMS to buckle and/or crease when the EWFMS flexes about a joint in one of the layers.

A magnetic sheeting portion of an EWFMS may have a thickness. For example, the thickness may be 30/1000 of an inch. The first joint may extend through at least a first portion of the thickness. The second joint may extend through at least a second portion of the thickness. The first portion of the thickness may be half the thickness.

The EWFMS may include an adhesive layer within the thickness. The adhesive layer may be positioned within the EWFMS between the second sheet and the third sheet and along the distance between the first joint and the second joint. The adhesive layer may maintain a position of each of the four magnetic sheets with respect to each of the other three magnetic sheets. The adhesive layer may comprise a pressure sensitive adhesive.

The EWFMS may include one printable layer. The EWFMS may include two or more printable layers. A first printable layer may be applied to the first and second magnetic sheets. The printable layer may be applied to the first magnetic sheet layer. The printable layer may be applied to the second magnetic sheet layer.

A second printable layer may be applied to the first printable layer. A printable layer may be a vinyl layer or any suitable material. A printable layer may include vinyl with a pressure sensitive adhesive.

A printable layer may be affixed to at least a portion of the first magnetic sheet. A printable layer may be affixed to at least a portion of the second magnetic sheet. A printable layer may span the first joint along at least a portion of the length. A printable layer may span the second joint along at least a portion of the length.

The EWFMS may include a polymer layer. The polymer layer may be polypropylene with a pressure sensitive adhesive. The polymer layer may be affixed to the third magnetic sheet. The polymer layer may be affixed to the fourth magnetic sheet. The polymer layer may span the second joint. The polymer layer may be affixed to a bottom of the second magnetic sheet layer. The polymer layer may span the first joint. The polymer layer may be affixed to a top of the first magnetic sheet layer.

Apparatus for an extended-width flexible magnetic sheet (“EWFMS”) are provided.

The EWFMS may include a top surface. The EWFMS may include a thickness t. Thickness t may be any suitable value of a portion of a total thickness T of the EWFMS. The thickness t may range from 5/1000 of an inch to 60/1000 of an inch. The EWFMS may include a length l. The EWFMS may include a joint extending along l and penetrating through t. The EWFMS may include a printable layer covering the top surface. The printable layer may be vinyl.

The joint may include a first mating surface. The joint may include a second mating surface. The first mating surface may be complementary to the second mating surface. At a complementary point of the joint, the first mating surface may be parallel to the second mating surface.

The thickness t of the EWFMS may range from 0<t<T. The thickness t may not include a thickness of a coating applied to the surface area of the EWFMS. The thickness t may include the thickness of the coating.

The joint may penetrate t in a direction perpendicular to a top surface of the EWFMS. The joint may penetrate t in a direction perpendicular to the top surface of the EWFMS for all values of t. The joint may penetrate t in a direction perpendicular to the top surface for all values of l. The joint may intersect the top surface at an angle between 0 degrees and 90 degrees. The joint may intersect the top surface at an angle between 0 degrees and 90 degrees for all values of t. The joint may intersect the top surface at an angle between 0 degrees and 90 degrees for all values of l.

At 0<t<T/2, the joint may include a first portion perpendicular to a top surface of the EWFMS. At t=T/2 the joint may include a second portion parallel to the top surface. At T/2<t<T, the joint may include a third portion perpendicular to the top surface.

In some embodiments, the third portion of the joint may include a strip of magnetic material between the first mating surface and the second mating surface. The strip of magnetic material may reduce a buckling of the EWFMS when the EWFMS is flexed.

At the third portion of the joint, the first mating surface may be spaced from the second mating surface by a distance d. A strip of magnetic material inserted into the third portion of the joint may have a width of slightly less than d. The strip of magnetic material may fill the distance d between the first mating surface and the second mating surface.

The joint may include any suitable shape along length l. For example, the first magnetic sheet may include protrusions that interlock with grooves in the second magnetic sheet. The first mating surface may interlock with the second mating surface. The joint may have a serpentine shape along l. The joint may be saw-tooth shaped, step-shaped, sinusoidal-shaped or any other suitable shape.

A mating surface of the joint may include any suitable shape along t. For example a mating surface may be step shaped, angled, curved, vertical or have any other suitable shape or curvature along t. The joint may have different shapes for different values of t, 0<t<T.

A mating surface of the joint may be formed using a dual-cut rotary die machine. The die machine may form a first mating surface by cutting an edge of a first magnetic sheet. The die machine may form a second mating surface on a second magnetic sheet. The second mating surface may be complementary to the first mating surface. The die machine may cut an edge of a second magnetic sheet to form the second mating surface.

The joint may include an adhesive between the first mating surface and the second mating surface. The adhesive may join the first flexible magnetic sheet to the second flexible magnetic sheet. In some embodiments, a printable layer covering a surface of the EWFMS may join the first flexible magnetic sheet to the second flexible magnetic sheet. The adhesive or printable layer may fix a position of the first mating surface with respect to the second mating surface. The first mating surface may be welded to the second mating surface.

Apparatus for an extended-width flexible magnetic sheet (“EWFMS”) are provided. The EWFMS may include a length. The EWFMS may include a first sheet of magnetic material. The EWFMS may include a second sheet of magnetic material. The EWFMS may include a joint along the length of the EWFMS. The joint may extend along the length between the first sheet and the second sheet.

The EWFMS may include a first vinyl layer. The first vinyl layer may be affixed to at least a portion of the first sheet. The first vinyl layer may be affixed to at least a portion of the second sheet. The first vinyl layer may cover the joint along at least a portion of the length of the EWFMS. The first vinyl layer may join the first sheet to the second sheet.

The first vinyl layer may cover a surface of the first sheet and a surface of the second sheet. The surface of the first sheet may include an entire top surface of the first sheet. The surface of the second sheet may include an entire top surface of the second sheet.

The first vinyl layer may couple the first sheet to the second sheet. The first vinyl layer may maintain a position of the first sheet with respect to the second sheet.

The EWFMS may include a second vinyl layer. The second vinyl layer may be affixed to the first vinyl layer. The second vinyl layer may cover the first vinyl layer. The second vinyl layer may cover substantially the entire first vinyl layer. The second vinyl layer may provide support to the joint. The second vinyl layer may resist a bending or a twisting of the EWFMS along the joint. A printer may print characters on the second vinyl layer. Characters printed on the second vinyl layer may not be distorted by a flexing of the EWFMS. Characters printed on the second vinyl layer may not be distorted by a gap within the joint. Constructing the EWFMS using two layers may reduce a tendency of a vinyl layer to buckle and/or crease when the EWFMS flexes about a joint.

The EWFMS may include a third vinyl layer affixed to the second vinyl layer. The third vinyl layer may cover the second vinyl layer. The third vinyl layer may cover substantially the entire second vinyl layer. The third vinyl layer may provide support to the joint. The third vinyl layer may resist a bending or twisting of the EWFMS along the joint. A printer may print characters on the third vinyl layer. The characters printed on the third vinyl layer may not be distorted by a flexing of the EWFMS. The characters printed on the third vinyl layer may not be distorted by a gap within the joint. Constructing the EWFMS using three vinyl layers may reduce a tendency of a vinyl layer to buckle and/or crease when the EWFMS flexes about a joint.

The joint may include a top along the length. The joint may include a bottom along the length. The EWFMS may include a polymer layer. The polymer layer may be polypropylene with a pressure sensitive adhesive (PSA). The polymer layer may be affixed to at least a portion of the first sheet. The polymer layer may be affixed to at least a portion of the second sheet.

The first vinyl layer may cover the top of the joint along the length of the EWFMS. The polymer layer may cover the bottom of the joint along the length of the EWFMS. The polymer layer may maintain a position of the first sheet with respect to the second sheet.

A vinyl layer may be affixed to a magnetic sheet using an adhesive. A polymer layer may be affixed to a magnetic sheet using an adhesive. The adhesive may be a coating applied to the vinyl or polymer layer.

Methods for constructing an expanded-width flexible magnetic sheet are provided. The methods may include aligning a first surface area of a first flexible magnetic sheet and a second surface area of a second flexible magnetic sheet. The first surface may be a top surface of the first sheet. The second surface may be a top surface of the second sheet. The methods may include joining a first flexible magnetic sheet to a second flexible magnetic sheet.

The aligning and/or joining may form a joint between the first flexible magnetic sheet and the second magnetic sheet.

The methods may include covering, along a length of the joint, the first surface area and the second surface area with a first vinyl layer. The first vinyl layer may be a third surface area of the EWFMS. The methods may include covering the first vinyl layer with a second vinyl layer. The second vinyl layer may cover the third surface area.

The methods may include covering, along the length of the joint, at least a portion of the first surface area and at least a portion of the second surface area with a polymer layer. The polymer layer may form a fourth surface area of the EWFMS. The polymer may be polypropylene with a pressure sensitive adhesive (PSA). The third surface may define a first normal vector S. The fourth surface may define a second normal vector −S.

The joint may include a first edge of the first flexible magnetic sheet. The joint may include a second edge of the second flexible magnetic sheet. The first edge and the second edge may remain unfused after forming the third surface area. The joint may include a gap between the first edge and the second edge.

The first flexible magnetic sheet may have a thickness t₀. The second flexible magnetic sheet may have the thickness t₀. The first vinyl layer may have a thickness t₁. The expanded width flexible magnetic sheet may have a thickness of at least t₀+t₁.

In a preferred embodiment, 0.005″≦t₀≦0.06″. In a preferred embodiment 0.001″≦t₁≦0.010″.

The polymer layer may have a third thickness t₂. The expanded width flexible magnetic sheet may have a fourth thickness of at least t₀+t₁+t₂.

In a preferred embodiment, 0.005″≦t₀≦0.060″, 0.001″≦t₁≦0.010″ and 0.001″≦t₂≦0.010″.

The methods may include covering the second vinyl layer with a third vinyl layer. The methods may include printing on the second vinyl layer. The methods may include printing on the third vinyl layer.

Apparatus for an extended-width flexible magnetic sheet are provided. The EWFMS may include a flexible top surface. The EWFMS may include a flexible bottom surface. The EWFMS may include a length l. The EWFMS may include a thickness t₀. In a preferred embodiment, 0.005″≦t₀≦0.060″. Thickness t₀ may extend between the top flexible surface and the bottom flexible surface.

The EWFMS may include a joint extending along at least a portion of length l. The joint may extend through at least a portion of t₀. The joint may include a first mating surface. The first mating surface may be an edge of a first flexible magnetic sheet. The joint may include a second mating surface. The second mating surface may be an edge of a second flexible magnetic sheet. The first flexible sheet and the second flexible sheet may be aligned along the joint to form the flexible surface of the EWFMS.

The joint may have a width. The width may be a distance between the first mating surface and the second mating surface. The width may be a gap between the first mating surface and the second mating surface.

The EWFMS may include a first flexible layer. The first flexible layer may be vinyl. The first flexible layer may cover the top flexible surface. The first flexible layer may cover substantially the entire top flexible surface.

The first flexible layer may cover the joint. The first flexible layer may cover the joint along the length l. For example, the first flexible layer may cover the width of the joint. As a further example, the first flexible layer may cover the gap between the first mating surface and the second mating surface.

The gap may be a space defined by a first mating surface, a second remaining surface, the first flexible layer and the third flexible layer. The gap may be empty.

The first flexible layer may be affixed to the flexible surface using an adhesive. The adhesive may be applied to a side of the first flexible layer. The adhesive may be applied to the flexible surface.

The EWFMS may include a second flexible layer. The second flexible layer may be vinyl. The second flexible layer may include one or more features of the first flexible layer. The second flexible layer may cover the first flexible layer. The second flexible layer may cover substantially the entire first flexible layer.

The EWFMS may include a third flexible layer. The third flexible layer may include one or more features of the first flexible layer. The third flexible layer may cover the second flexible layer. For example, the third flexible layer may be affixed to the second flexible layer and cover substantially the entire second flexible layer.

The third flexible layer may be a polymer layer. The third flexible layer may be affixed to a bottom flexible surface of the EWFMS. The third flexible layer may cover the bottom flexible surface. The third flexible layer may cover substantially the entire bottom flexible surface. The third flexible layer may cover the joint.

The first flexible sheet may have thickness t₀. The second flexible sheet may have thickness t₀. The first flexible layer may have a thickness t₁. In a preferred embodiment, 0.001″≦t₂≦0.010″. The second flexible layer may have a thickness t₂. A total thickness t_{T} of the EWFMS may be greater than or equal to: t₀+t₁+t₂.

The first flexible layer may have a thickness of t₁. The second flexible layer may have a thickness of t₂. The third flexible layer may have a thickness of t₃. A total thickness t_{T} of the EWFMS may be greater than or equal to: t₀+t₂+t₂+t₃.

In a preferred embodiment:
0.005″≦t₀≦0.060″;
0.001″≦t₁≦0.010″;
0.001″≦t₂≦0.010″; and
0.0005″≦t₃≦0.002″.

Apparatus for an extended-width flexible magnetic sheet are provided. The EWFMS may include a first magnetic panel having a width w₁. The first magnetic panel may have a thickness t₀. The EWFMS may include a second magnetic panel. The second magnetic panel may have a width w₂. The second magnetic panel may have the thickness t₀.

The EWFMS may include a vinyl layer. The vinyl layer may have a thickness t₁. The vinyl layer may be affixed to the first magnetic panel. The vinyl layer may be affixed to the second magnetic panel. The vinyl layer may cover w₁. The vinyl layer may cover w₂. The vinyl layer may bridge a joint between the first panel and the second panel.

The EWFMS may have thickness tₛ. In a preferred embodiment tₛ≧t₀+t₁. The EWFMS may have a width wₛ. In a preferred embodiment, wₛ>w₂ and wₛ>w₂.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

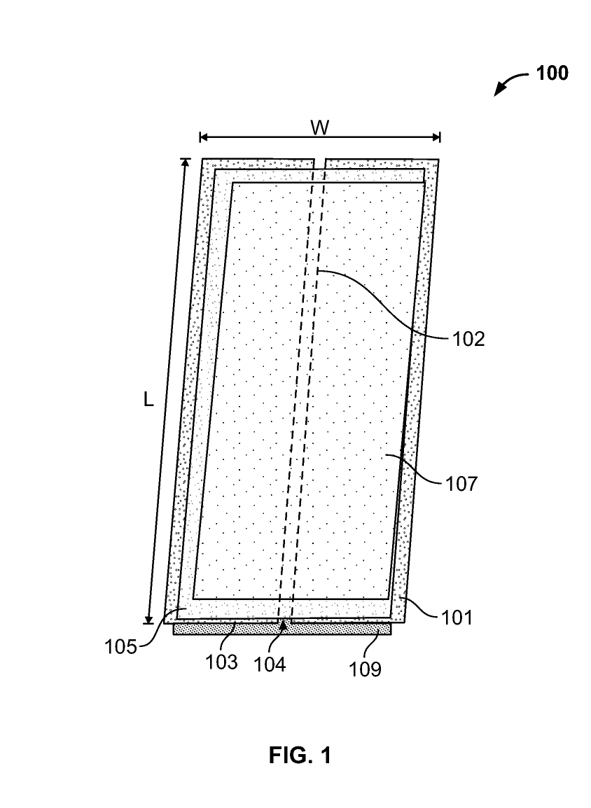

FIG. 1 shows an illustrative perspective view of a portion of an extended-width flexible magnetic sheet (“EWFMS”) 100. EWFMS 100 includes first magnetic sheet 101. EWFMS includes second magnetic sheet 103. First magnetic sheet 101 and second magnetic sheet 103 may be aligned along joint 102. Joint 102 may include an edge (not shown) of first magnetic sheet 101. Joint 102 may include an edge of second magnetic sheet 103. Joint 102 may include gap 104 between first magnetic sheet 101 and second magnetic sheet 103.

EWFMS includes length L. EWFMS includes width W. Width W may be greater than a width of first magnetic sheet 101. Width W may be greater than a width of second magnetic sheet 103. Joint 102 may extend along at least a portion of length L.

EWFMS 100 includes first flexible layer 105. First flexible layer 105 may be vinyl. First flexible layer 105 may be affixed to first flexible magnetic sheet 101. First flexible layer 105 may be affixed to second flexible magnetic sheet 103. First flexible layer 105 may join first flexible magnetic sheet 101 to second flexible magnetic sheet 103. First flexible layer 105 may maintain an alignment of first flexible sheet 101 with respect to second flexible magnetic sheet 103. First flexible layer 105 may cover joint 102. An adhesive (not shown) may affix first flexible layer 105 to first magnetic sheet 101 and/or second flexible magnetic sheet 103.

EWFMS 100 includes second flexible layer 107. Second flexible layer 107 may be vinyl. Second flexible layer 107 may be affixed to first flexible layer 105. Second flexible layer 107 may be affixed to first flexible layer using an adhesive (not shown). The adhesive may be applied to a surface of second flexible layer 107. The adhesive may be applied to a surface of first flexible layer 105. Second flexible layer 107 may resist a bending of EWFMS 100 along joint 102. Second flexible layer 107 may prevent distortion when printing characters on a surface of second flexible layer 107 over joint 102. Constructing EWFMS 100 using first flexible layer 107 and second flexible layer 107 may reduce a tendency of second flexible layer 107 to buckle and/or crease when the EWFMS flexes about joint 102.

EWFMS 100 includes third flexible layer 109. Third flexible layer 109 may be a polymer. Third flexible layer 109 may be affixed to first flexible magnetic sheet 101. Third flexible layer 109 may be affixed to second flexible magnetic sheet 103. Third flexible layer 109 may join first flexible magnetic sheet 101 to second flexible magnetic sheet 103. Third flexible layer 109 may cover joint 102.

Third flexible layer 109 may maintain an alignment of first flexible magnetic sheet 101 with respect to second flexible magnetic sheet 103. An adhesive (not shown) may affix third flexible layer 109 to first magnetic sheet 101 and/or second flexible magnetic sheet 103. The adhesive may be applied to a surface of third flexible layer 109. Third flexible layer 109 may resist a bending of EWFMS 100 along joint 102. Third flexible layer 109 may prevent distortion when printing characters on second flexible layer 107 over joint 102. Third flexible layer 109 reduce a tendency of second flexible layer 107 to buckle and/or crease when EWFMS 100 is flexed about joint 102.

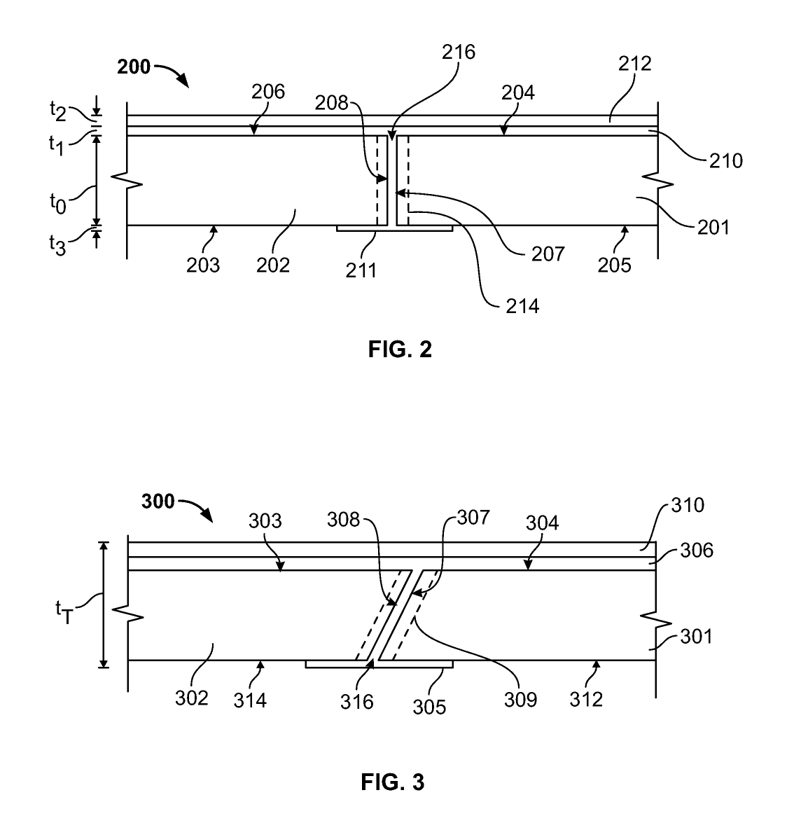

FIG. 2 shows an illustrative cross-section of EWFMS 200. EWFMS 200 may include one or more features of EWFMS 100. EWFMS 200 includes first flexible magnetic sheet 201. EWFMS 200 includes second flexible magnetic sheet 202. FIG. 2 shows that first flexible magnetic sheet 201 and second flexible magnetic sheet 202 have thickness t₀.

First flexible magnetic sheet 201 includes first mating surface 207. Second flexible magnetic sheet 202 includes second mating surface 208. Joint 214 includes first mating surface 207 and second mating surface 208. Joint 214 includes gap 216 between first mating surface 207 and second mating surface 208.

First flexible magnetic sheet 201 includes top surface 204. Second flexible magnetic sheet 202 includes top surface 206. First flexible layer 210 covers top surface 206, top surface 204 and joint 214. First flexible layer 210 has a thickness t₁. First flexible layer 210 may maintain a position of first flexible magnetic sheet 201 with respect to second flexible magnetic sheet 202. First flexible layer 210 may be affixed using an adhesive (not shown). First flexible layer 210 may be vinyl.

EWFMS 200 includes second flexible layer 212. Second flexible layer 212 has thickness t₂. Second flexible layer 212 may be vinyl. Second flexible layer 212 may be affixed to first flexible layer 210. Second flexible layer 212 may be configured to resist a bending of EWFMS 200 along joint 214. Second flexible layer 212 may be configured to prevent a distortion of characters printed on second flexible layer 212 when EWFMS 200 is bent along joint 214. Second flexible layer 212 may prevent distortion when printing characters across joint 214. Constructing EWFMS 200 using first flexible layer 210 and second flexible layer 212 may reduce a tendency of second flexible layer 212 to buckle and/or crease when EWFMS 200 flexes about joint 214.

First magnetic sheet 201 includes bottom surface 205. Second flexible magnetic sheet 202 includes bottom surface 203. Third flexible layer 211 is affixed to bottom surface 203, bottom surface 205 and joint 214. Third flexible layer 211 has thickness t₃. A total thickness of EWFMS 200 is preferably not less than t₀+t₁+t₂+t₃.

Third flexible layer 211 may maintain a position of first magnetic sheet 201 with respect to second magnetic sheet 202. Third flexible layer 211 may be configured to resist a bending of EWFMS 200 along joint 214. Third flexible layer 211 may prevent distortion when printing characters over joint 214. Third flexible layer 211 may reduce a tendency of second flexible layer 212 to buckle and/or crease when EWFMS 200 flexes about joint 214.

FIG. 3 shows illustrative cross-section of EWFMS 300. EWFMS 300 has thickness t_{T}. EWFMS 300 may include one or more features of EWFMS 100 and/or 200. EWFMS 300 includes first flexible magnetic sheet 301. First flexible magnetic sheet 301 includes first mating surface 307. FIG. 3 shows that first mating surface 307 is angularly oriented with respect to thickness t_{T}.

EWFMS 300 includes joint 309. In FIG. 3, joint 309 is shown being angularly oriented with respect to thickness t_{T}. In other embodiments (not shown), joint 309 may be perpendicular to thickness t_{T}. Joint 309 includes gap 316 between mating surface 307 and mating surface 308.

EWFMS 300 includes first flexible layer 306. Flexible layer 306 may align flexible magnetic sheet 301 with respect to flexible magnetic sheet 302. EWFMS 300 includes flexible layer 310. Flexible layer 310 may be applied to flexible layer 306.

EWFMS 300 includes second flexible magnetic sheet 302. First flexible magnetic sheet 302 includes second mating surface 308. FIG. 3 shows that second mating surface 308 is angularly oriented with respect to thickness t_{T}.

Magnetic sheet 301 includes bottom surface 312. Magnetic sheet 302 includes bottom surface 314. Flexible layer 305 may be applied to bottom surface 312 and bottom surface 314 across joint 309.

Joint 309, when angularly oriented with respect to thickness t_{T}, may reduce a tendency of flexible layer 306 and/or flexible layer 310 to buckle and/or crease when EWFMS 300 flexes about thickness t_{T}. Joint 309, when angularly oriented with respect to thickness t_{T}, may reduce a depth of a gap, with respect to flexible layer 306, between mating surface 308 and mating surface 307.

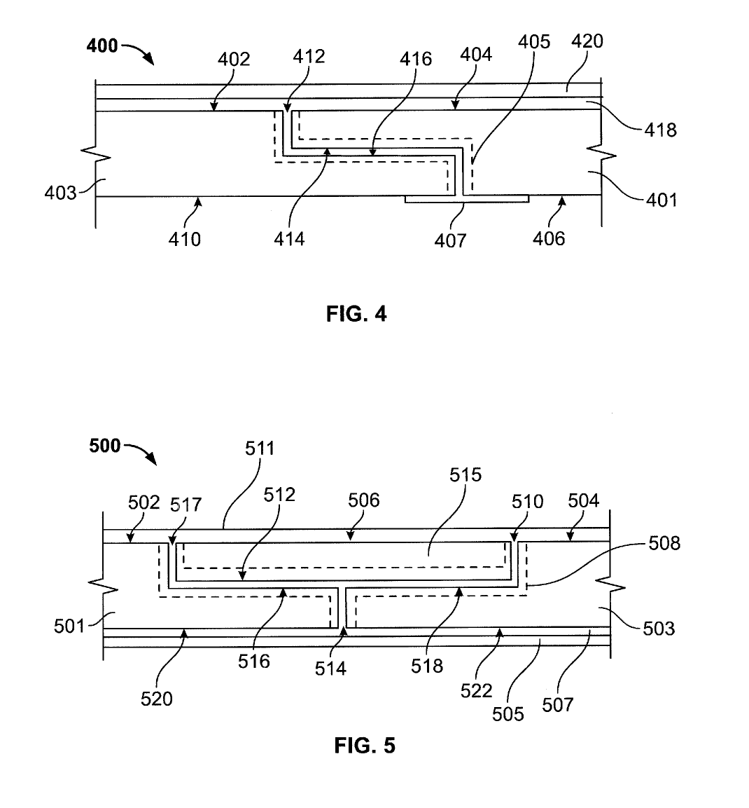

FIG. 4 shows illustrative cross-section of EWFMS 400. EWFMS 400 may include one or more features of EWFMS 100, 200 and/or 300. EWFMS 400 includes first magnetic sheet 401. First magnetic sheet 401 includes top surface 404. First magnetic sheet 401 includes bottom surface 406. First magnetic sheet 401 includes first mating surface 414.

EWFMS 400 includes second magnetic sheet 403. Second magnetic sheet 403 includes top surface 402. Second magnetic sheet 403 includes second mating surface 416. Second magnetic sheet 403 includes bottom surface 410.

EWFMS 400 includes joint 405. Joint 405 extends between top surface 404 and bottom surface 406. Joint 405 extends between top surface 402 and bottom surface 410. An intersection of top surface 404 and first mating surface 414 is covered by first flexible layer 418. An intersection of top surface 402 and second mating surface 416 is covered by first flexible layer 418. Joint 405 may include gap 412 between first mating surface 414 and second mating surface 416. First flexible layer 418 may cover gap 412.

EWFMS 400 includes second flexible layer 420. Second flexible layer 420 may be affixed to first flexible layer 418. Second flexible layer 420 may increase a bending resistance of an EWFMS such as EWFMS 400. Second flexible layer 420 may prevent distortion when printing across joint 405. First flexible layer 418 and second flexible layer 420 may reduce a tendency of second flexible layer 420 to buckle and/or crease when EWFMS 200 flexes about joint 405.

EWFMS 400 includes third flexible layer 407. Third flexible layer 407 may be affixed to bottom surface 406 and bottom surface 410. Third flexible layer 407 may cover a point of intersection between first mating surface 414 and bottom surface 406. Third flexible layer 407 may cover a point of intersection between second mating surface 416 and bottom surface 410. Third flexible layer 407 may increase a bending resistance of EWFMS 400. Third flexible layer 407 may prevent distortion when printing across joint 405. Third flexible layer 407 may reduce a tendency of second flexible layer 420 to buckle and/or crease when EWFMS 200 flexes about joint 405.

FIG. 5 shows an illustrative cross-section of EWFMS 500. EWFMS 500 may include one or more features of EWFMS 100, 200, 300 and/or 400. EWFMS 500 includes magnetic sheet 501. Magnetic sheet 501 includes mating surface 516. EWFMS 500 includes magnetic sheet 503. Magnetic sheet 503 includes mating surface 518. EWFMS 500 includes magnetic strip 515. Magnetic strip 515 includes mating surface 512.

EWFMS 500 includes joint 508. Joint 508 includes mating surface 516 of magnetic sheet 501. Joint 508 includes mating surface 518 of magnetic sheet 503. Joint 508 includes mating surface 512 of magnetic strip 515. Mating surfaces 516 and 512 may define a first portion of joint 508. Mating surfaces 512 and 518 define a second portion of joint 508. Mating surfaces 516 and 518 define a third portion of joint 508.

Magnetic sheet 501 includes top surface 502. Magnetic sheet 503 includes top surface 504. Magnetic strip 515 includes top surface 506. Flexible layer 511 may join magnetic sheet 501 to magnetic strip 515. Flexible layer 511 may join magnetic sheet 503 to magnetic strip 515. Flexible layer 511 may cover gap 517 in joint 508. Flexible layer 511 may cover gap 510 and join magnetic strip 515 to magnetic sheet 503.

Magnetic sheet 501 includes bottom surface 520. Magnetic sheet 503 includes bottom surface 522. EWFMS 500 includes flexible layer 507. Flexible layer 507 joins bottom surface 520 to bottom surface 522. Flexible layer 507 may cover gap 514 in joint 508.

EWFMS 500 includes flexible layer 505. Flexible layer 505 may be affixed to flexible layer 507. Flexible layer 507 may allow for printing on flexible layer 505 across joint 508 without distortion across gap 514. Flexible layer 505 may reduce a tendency of flexible layer 507 to buckle and/or crease when EWFMS 500 flexes about joint 508.

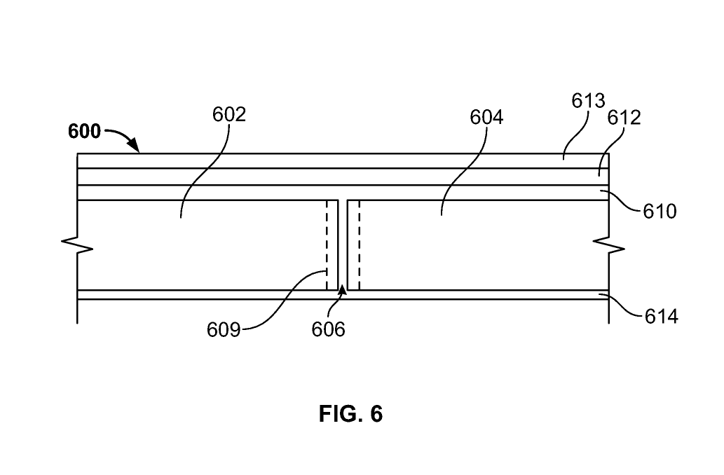

FIG. 6 shows an illustrative cross-section of EWFMS 600. EWFMS 600 may include one or more features of EWFMS 100, 200, 300, 400 and/or 500.

EWFMS includes joint 609. Joint 609 may include gap 606 between magnetic sheet 602 and magnetic sheet 604. First flexible layer 610 may join magnetic sheet 602 and magnetic sheet 604.

EWFMS 600 includes second flexible layer 612. Second flexible layer 612 may be affixed to first flexible layer 610. Second flexible layer 612 may prevent distortion when printing across joint 609. EWFMS 600 may include third flexible layer 613. Third flexible layer 613 may be affixed to second flexible layer 612. Third flexible layer 613 may prevent distortion when printing on third flexible layer 613 across joint 609 and/or gap 606. First flexible layer 610 and second flexible layer 612 may reduce a tendency of third flexible layer 613 to buckle and/or crease when EWFMS 600 flexes about joint 609.

EWFMS 600 includes fourth flexible layer 614. Fourth flexible layer 614 may join magnetic sheet 602 to magnetic sheet 604. Fourth flexible layer 614 may increase a resistance to bending of EWFMS 600. Fourth flexible layer 614 may prevent material printed across joint 609 from being distorted by joint 609 and/or gap 606. Fourth flexible layer 614 may reduce a tendency of third flexible layer 613 to buckle and/or crease when EWFMS 600 flexes about joint 609.

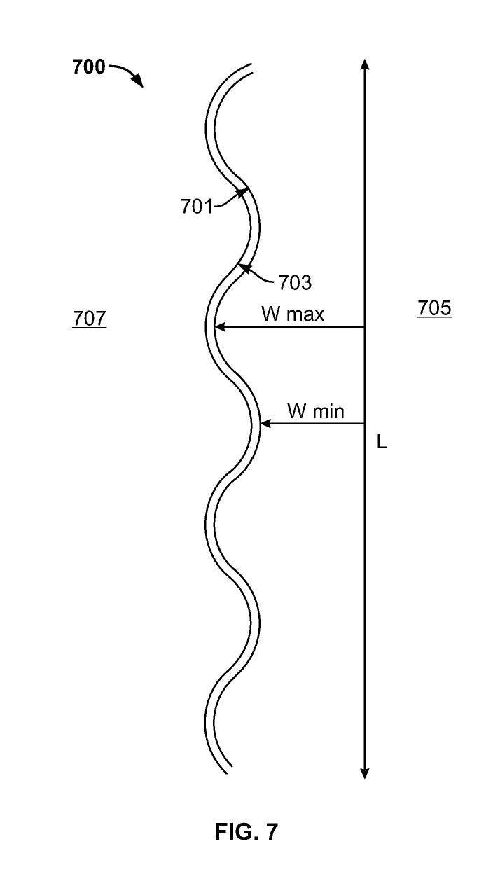

FIG. 7 shows a top-down view of an illustrative joint 700. Joint 700 is shown along a length L of an EWFMS. Joint 700 is between flexible magnetic sheet 707 and flexible magnetic sheet 705. Flexible magnetic sheet 707 includes mating surface 703. Flexible magnetic sheet 705 includes mating surface 701.

Mating surfaces 701 and 703 follow complementary serpentine paths along length L. A serpentine path may be a sinusoidal path. A width (not shown) may be measured from an axis defined by L. A width measured from L may vary between a maximum and a minimum. For example, a width of flexible magnetic sheet 705, measured from L may vary along L between wₘᵢₙ and wₘₐₓ.

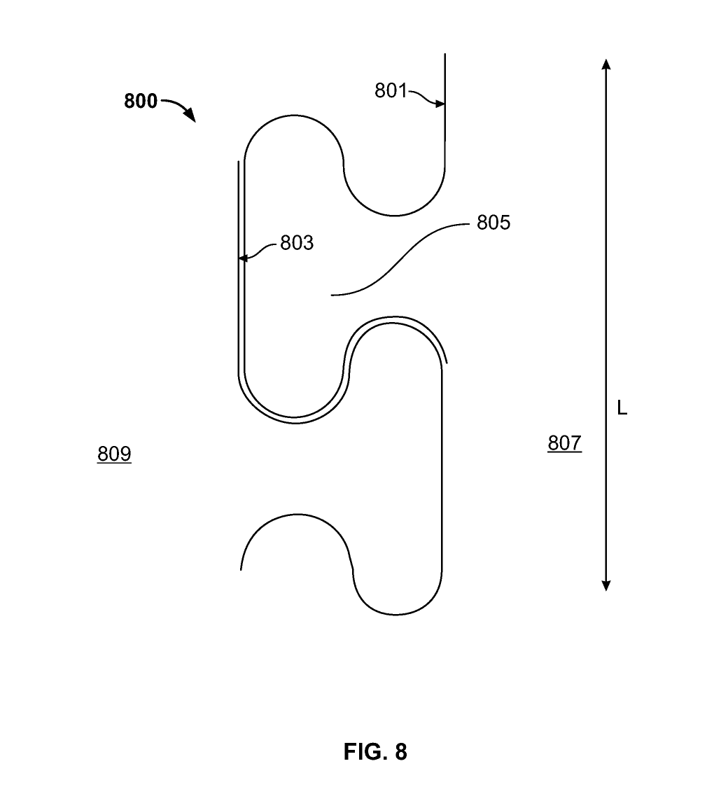

FIG. 8 shows a top-down view of illustrative joint 800 along a length l of an EWFMS. Joint 800 includes mating surface 803 of flexible magnetic sheet 809. Joint 800 includes mating surface 801 of flexible magnetic sheet 807. Mating surface 803 may be complementary to mating surface 801. Mating surface 801 may extend around protrusion 805 of flexible magnetic sheet 807. Flexible magnetic sheet 809 may include a complementary groove (not shown) configured to interlock with protrusion 805. Interlocking mating surface 801 with mating surface 803 may maintain a position of sheet 807 with respect to sheet 809. Interlocking mating surface 801 with mating surface 803 may maintain a position of sheet 807 with respect to sheet 809 without applying an adhesive to mating surface 801 or mating surface 803.

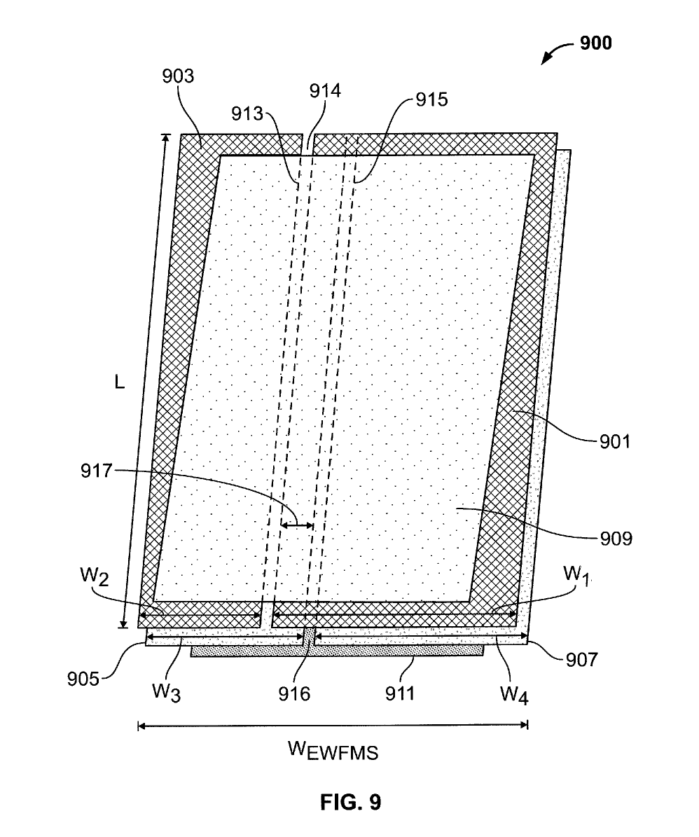

FIG. 9 shows a perspective view of illustrative EWFMS 900. EWFMS 900 includes first magnetic sheet 901. First magnetic sheet 901 has a width w₁. First magnetic sheet 901 is aligned with second magnetic sheet 903. Second magnetic sheet 903 has a width w₂.

Aligning first magnetic sheet 901 with second magnetic sheet 903 may form a first magnetic sheet layer of EWFMS 900. The first sheet magnetic layer may have a width of w₁+w₂. The width of the first magnetic sheet layer may equal w_{EWFMS}. First magnetic sheet 901 may be aligned with second magnetic sheet 903 along first joint 913.

EWFMS 900 includes third magnetic sheet 905. Third magnetic sheet 905 has a width w₃. Third magnetic sheet 905 is aligned with fourth magnetic sheet 907. Fourth magnetic sheet 907 has a width w₄.

Aligning third magnetic sheet 905 with fourth magnetic sheet 907 may form a second magnetic sheet layer of EWFMS 900. The second magnetic sheet layer may have a width of w₃+w₄. The width of the second surface may equal w_{EWFMS}.

Third magnetic sheet 905 may be aligned with fourth magnetic sheet 907 along second joint 915. Second joint 915 is offset from first joint 913 by distance 917.

First magnetic sheet 901 may be joined to fourth magnetic sheet 907 with an adhesive (not shown). Second magnetic sheet 903 may be joined to third magnetic sheet 905 with an adhesive. First magnetic sheet 901 may be joined to third magnetic sheet 905 with an adhesive. The adhesive may join the first surface to the second surface. Alternatively, EWFMS 900 may not include an adhesive between the first and second flexible magnetic sheet layers.

EWFMS 900 may include printable layer 909. Printable layer 909 may be vinyl. Printable layer 909 may be affixed to first magnetic sheet 901. Printable layer 909 may be affixed to second magnetic sheet 903.

Offset 917 may increase a resistance to bending of EWFMS 900. Offset 917 may prevent distortion when printing on printable layer 909 across joint 913 and/or gap 914. Offset 917 may prevent material printed across joint 913 from being distorted by joint 913 and/or gap 914.

Offset 917 may prevent distortion when printing on printable layer 909 across joint 915 and/or gap 916. Offset 917 may prevent material printed across joint 915 from being distorted by joint 915 and/or gap 916. Offset 917 may increase a bending resistance of EWFMS 900. Offset 917 may reduce a tendency of layer 909 to buckle and/or crease when EWFMS 900 is flexed about joint 913 and/or joint 915.

EWFMS 900 includes layer 911. Layer 911 may be a polymer layer. Layer 911 may be affixed to third magnetic sheet 907. Layer 911 may be affixed to fourth magnetic sheet 907. Layer 911 may join third magnetic sheet 905 to fourth magnetic sheet 907. Layer 911 preferably spans joint 915. Layer 911 may maintain an alignment of third magnetic sheet 905 with respect to fourth magnetic sheet 907.

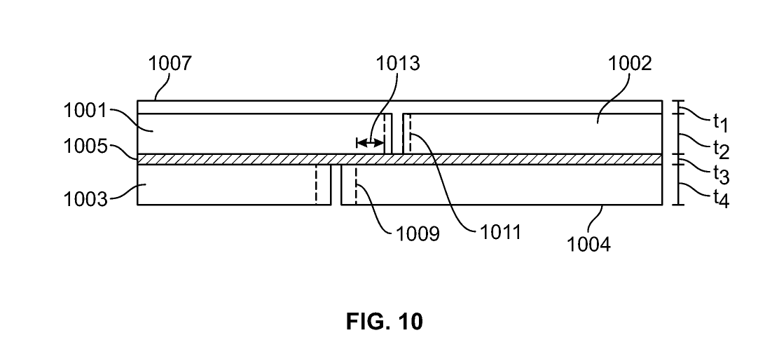

FIG. 10 shows a cross-section of illustrative EWFMS 1000. EWFMS 1000 includes first flexible magnetic sheet 1001. EWFMS 1000 includes second flexible magnetic sheet 1002. EWFMS 1000 includes third flexible magnetic sheet 1003. EWFMS 1000 includes fourth flexible magnetic sheet 1004.

First flexible magnetic sheet 1001 is aligned with second flexible magnetic sheet 1002 along joint 1011. Aligning first flexible magnetic sheet 1001 with second flexible magnetic sheet 1002 may form a first flexible magnetic layer of EWFMS 1000. Third flexible magnetic sheet 1003 is aligned with fourth flexible magnetic sheet 1004 along joint 1009. Aligning third flexible magnetic sheet 1003 with fourth flexible magnetic sheet 1004 may form a second flexible magnetic sheet layer of EWFMS 1000.

EWFMS 1000 includes adhesive layer 1005. Adhesive layer 1005 may join first flexible magnetic sheet 1001 to third flexible magnetic sheet 1003. Adhesive layer 1005 may join second flexible magnetic surface 1002 to fourth flexible magnetic surface 1004. Adhesive layer 1005 may join fourth flexible magnetic surface 1004 to first flexible magnetic surface 1001.

EWFMS 1000 includes printable layer 1007. Printable layer 1007 may be affixed to a flexible magnetic sheet using a pressure sensitive adhesive. Printable layer 1007 may be affixed to first flexible magnetic sheet 1001. Printable layer 1007 may be affixed to second flexible magnetic sheet 1002. Printable layer 1007 spans joint 1011.

EWFMS 1000 includes offset 1013. Offset 1013 separates joint 1011 from joint 1009. Offset 1013 may prevent distortion when printing on printable layer 1007 across joint 1011. Offset 1013 may prevent material printed across joint 1011 from being distorted by joint 1011. Offset 1013 may increase a bending and or creasing resistance of EWFMS 1000. Offset 1013 may reduce a tendency of printable layer 1007 to buckle and/or crease when EWFMS 1000 is flexed about joint 1009 and/or joint 1011.

Printable layer 1007, including an adhesive for adhering layer 1007 to a flexible magnetic sheet, has a thickness t₁. First flexible magnetic sheet 1001 has a thickness t₂. Second flexible magnetic sheet 1002 may also have the thickness t₂. Adhesive layer 1005 has a thickness t₃. Third flexible magnetic sheet 1003 has a thickness t₄. Fourth flexible magnetic sheet 1004 may also have the thickness t₄. A total thickness of EWFMS 1000 is t₁+t₂+t₃+t₄.

Thus, apparatus and methods for an extended-width magnetic sheet have been provided. Persons skilled in the art will appreciate that the present invention can be practiced by other than the described embodiments, which are presented for purposes of illustration rather than of limitation. For example, described herein may be performed in other than the recited order and that one or more steps illustrated may be optional. The present invention is limited only by the claims that follow.

What is claimed is:

1. An extended-width flexible magnetic sheet (“EWFMS”) comprising:
a length;
a first magnetic sheet layer comprising:
a first sheet of magnetic material;
a second sheet of magnetic material; and
a first joint between the first sheet and the second sheet along at least a portion of the length;
a second magnetic sheet layer comprising:
a third sheet of magnetic material;
a fourth sheet of magnetic material; and
a second joint between the third sheet and the fourth sheet along at least the portion of the length; and
an adhesive layer joining the first magnetic sheet layer to the second magnetic sheet layer.

2. The EWFMS of claim 1 wherein:
the first sheet has a first width w₁;
the second sheet has a second width w₂;
the third sheet has a third width w₃; and
the fourth sheet has a fourth width w₄.

3. The EWFMS of claim 2 wherein:
the first magnetic sheet layer has a width wₛ₂ equal to w₁+w₂;
the second magnetic sheet layer has a width wₛ₂ equal to w₃+w₄; and
wₛ₁=wₛ₂.

4. The EWFMS of claim 1 wherein the second joint is offset from the first joint by a distance.

5. The EWFMS of claim 4 wherein the distance is greater than or equal to one inch.

6. The EWFMS of claim 1 further comprising a thickness, and wherein:
the first joint extends through at least a first portion of the thickness; and
the second joint extends through at least a second portion of the thickness.

7. The EWFMS of claim 1 further comprising a vinyl layer, the vinyl layer:
affixed to at least a portion of the first magnetic sheet;
affixed to at least a portion of the second magnetic sheet; and
spanning the first joint along at least the portion of the length.

8. The EWFMS of claim 1 wherein the adhesive layer spans the second joint along at least the portion of the length.

9. The EWFMS of claim 6 wherein the adhesive layer is positioned within the thickness.

10. The EWFMS of claim 6 wherein the adhesive layer is positioned:
within the thickness;
between the second sheet and the third sheet; and
along the distance between the first joint and the second joint.

11. An extended-width flexible magnetic sheet (“EWFMS”) comprising:
a length;
a first sheet of magnetic material;
a second sheet of magnetic material;
a joint along the length between the first sheet and the second sheet;
a first vinyl layer:
affixed to at least a portion of the first sheet;
affixed to at least a portion of the second sheet; and
covering the joint along the length; and
a second vinyl layer affixed to the first vinyl layer.

12. A method of constructing an extended-width flexible magnetic sheet (“EWFMS”), the method comprising:
aligning a first surface area of a first flexible magnetic sheet and a second surface area of a second flexible magnetic sheet, wherein the aligning forms a joint between the first flexible magnetic sheet and the second magnetic sheet;
forming a third surface area by covering, along a length of the joint, the first surface area and the second surface area with a first vinyl layer; and
covering the first vinyl layer with a second vinyl layer.

13. An extended-width flexible magnetic sheet (“EWFMS”) comprising:
a top flexible surface;
a bottom flexible surface;
a length l;
a thickness t₀ between the top flexible surface and the bottom flexible surface;
a joint extending along 1 and through at least a portion of t₀, the joint comprising:
a first mating surface; and
a second mating surface;
a first flexible layer covering the joint and the top flexible surface; and
a second flexible layer covering the first flexible layer.

14. The EWFMS of claim 13 wherein the first flexible layer and the second flexible layer are vinyl.

15. The magnetic sheet of claim 13 further comprising a third flexible layer covering the joint and the bottom flexible surface.

16. The magnetic sheet of claim 15 wherein the third flexible layer is a polymer layer.

17. The magnetic sheet of claim 13 further comprising a third flexible layer covering the second flexible layer.

18. The magnetic sheet of claim 17, wherein a space defined by the first mating surface, the second remaining surface, the first flexible layer and the third flexible layer is empty.

19. The magnetic sheet of claim 13 wherein:
the first flexible layer has a thickness t₁:
the second flexible layer has a thickness t₂; and
a total thickness t_{T} of the magnetic sheet is greater than or equal to: t₀+t₁+t₂.

20. The magnetic sheet of claim 19 wherein:
0.005″≦t₀≦0.06″;
0.001″≦t₁≦0.0010″; and
0.001″≦t₂≦0.0010″.
